(19) United States
(12) Patent Application Publication
(10) Pub. No.: US 2004/0185723 A1
(43) Pub. Date: Sep. 23, 2004

(54) Motorized watercraft

(76) Inventor: Andrea Grimmeisen, Stuttgart (DE)

Correspondence Address: Pauley Petersen & Erickson, Suite 365, 2800 W. Higgins Road, Hoffman Estates, IL, 60195, US

(21) Appl. No.: 10/765,351

(22) Filed: Jan. 27, 2004

Related U.S. Application Data
(63) Continuation of application No. 10/009,626, filed on Apr. 1, 2002, now Pat. No. 6,682,372.
Application No. 10/009,626 is a 371 of international application No. PCT/EP01/01835, filed on Feb. 19, 2001.

(30) Foreign Application Priority Data
Feb. 26, 2000 (DE) 100 09 197.0
Feb. 28, 2000 (DE) 100 09 278.0

(51) Int. Cl. B60L 11/02

(52) U.S. Cl. 440/6

(57) ABSTRACT

A motorized watercraft having a hull on which the user can lie or stand wherein a flow channel is provided with an engine-driven water screw. The electric engine, batteries and control device for the electric engine are accommodated in the hull of the watercraft. The water screw, electric engine and control device are embodied as a drive unit and positioned in the flow channel. The batteries for the electric engine are arranged in a separate, interchangeable housing which is built into the hull of the watercraft. As a result, the motorized watercraft has a substantially simplified structure, is user friendly and easy to maintain.

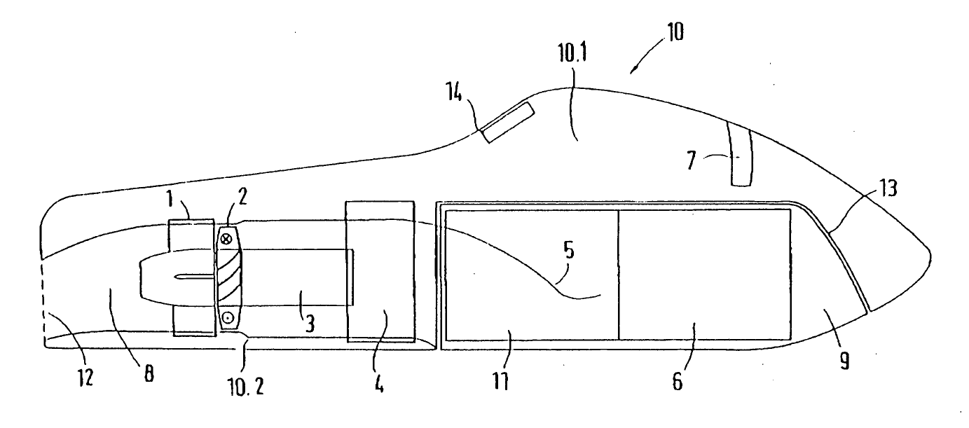

The invention relates to a motorized watercraft with a hull of the craft, on which the user lies prone or stands, with a flow channel extending in the hull of the craft with a motor-driven water screw, wherein the electric motor and the batteries, as well as the control device for the electric motor are housed in the hull of the craft.

A motorized watercraft of this type is known from WO 96/30087. There, the user lies prone on the hull of the craft, and the water screw in the flow channel is driven by a battery-powered electric motor in such a way that a water flow is aspirated through the flow channel which extends opposite the movement direction of the motorized watercraft. In this way the water flow can be kept away from the user, and the flow of the channel water can also conducted past the user by means of the shape of the hull of the watercraft. This makes swimming and diving by means of the motorized watercraft easier.

The design of the structure of the motorized watercraft is complicated and is not user-friendly in respect to maintenance.

It is the object of the invention to simplify a motorized watercraft of the type mentioned at the outset and to design it to be user-friendly.

In accordance with the invention, this object is attained in that the water screw, the electric motor and the control device are designed as an underwater drive unit and are placed in the flow channel, and that the batteries for the electric motor are placed into a separate housing, which is installed in the hull of the craft so that it can be exchanged.

The combination of the water screw, the electric motor and the control device for the electric motor into one underwater unit, and their placement in the flow channel results in a considerable simplification of the structure of the elements, in particular the hull of the craft, and of the maintenance of the motorized watercraft. The batteries placed into a separate housing can be easily removed for charging and can be replaced by a new housing containing charged batteries.

This rapid replacement makes the motorized watercraft particularly ready for use and is therefore user-friendly, since it can be employed very rapidly and therefore practically always.

Because the electric motor is seated directly in the flow channel, it is cooled by the water flow. In this way it is possible to omit additional cooling devices. Because of this the parts outlay for the motorized watercraft is considerably further reduced. If required, the control device can also be cooled in the same way.

If in accordance with an embodiment it is provided that the hull of the craft has a surface for prone use or a platform for the user above the flow channel, it can be used in two ways of employment.

The construction can be further simplified by forming the flow channel as one piece with the hull of the craft.

An embodiment has been proven to be particularly advantageous which is distinguished in that the flow channel starts with an inflow opening in the area of the bow of the hull of the craft and terminates in an outflow opening in the area of the stem of the hull of the craft, and that the underwater drive unit is installed in the flow channel as a suction device.

In accordance with an embodiment, the housing of the batteries has be solved in such a way that the housing with the batteries is inserted into a recess formed in the underside of the hull of the craft which is arranged outside of the flow channel and the inflow opening in the area of the bow of the hull of the craft.

An embodiment is advantageous for the two different types of employment of the motorized watercraft while in the prone or standing position, which is distinguished in that a remote control device is assigned to the underwater drive unit, which is releasably attached to the hull of the craft and can be brought into operative contact with the control device of the underwater unit over a wireless transmission path.

For a simple maintenance or repair of the underwater drive unit it is additionally provided that the hull of the craft has a plate, flap or the like, which can be opened, in the flow channel below the underwater drive unit, through which access to the underwater unit is provided.

The invention will be explained in greater detail by means of a motorized watercraft represented in a lateral view in the drawing.

The exterior shape of the hull 10 of the craft essentially corresponds to the exterior shape of the hull of the motorized watercraft known from WO 96/30087. The flow channel 8 extends from the inflow opening 11 in the area of the bow to the flow exit 12 in the area of the stem of the hull 10 of the craft. An underwater drive unit consisting of a stator 1, an electric motor 3, a water screw 2 and the motor control device 4 has been installed in the flow channel 8, which is slightly downward curved in the areas of the inflow opening 11 and the outflow opening 12. In the present case the stator 1 is in stationary connection with the hull 10 of the craft. In addition to its actual electric motor function, it also has the function of straightening the rotating water flow generated in the flow channel 8. An increase in efficiency is achieved by this. Such underwater drive units can today be designed in such a way that they can be employed in flowing water without problems. Therefore the hull 10 can be freely provided outside of the flow channel 8 and can be designed as simply as possible, but as well as possible in regard to advantageous flow and user-friendly.

The flow channel 8 can be formed in one piece with the hull 10 of the craft. In the present exemplary embodiment the flow channel 8 is constituted by an upper shell 10.1 and a lower shell 10.2. These components are connected with each other by suitable fastening means. The flow channel 8 is made accessible for maintenance of the underwater drive unit by removing the lower shell 10.2. But a plate, flap, or the like can be provided below the underwater drive unit, by means of which an access to the underwater drive unit exists.

A recess 13 has been formed in the underside in the area of the bow of the upper shell 10.1 of the shell 10 of the hull, into which a housing 9 with batteries 5 and 6 has been releasably inserted. The housing 9 with the chargeable batteries 5 and 6 can be easily and rapidly exchanged and can be replaced by a housing 9 with charged batteries 5 and 6, so that the motorized watercraft is always ready for use.

The area of the inflow opening 11 of the flow channel 8 is covered at the top by means of the housing 9 in such a way that easy access to the rotor 2 is prevented, but water can be conveyed at a sufficient flow volume. By means of this simple step it is achieved that the rotor 2 is only accessible when the housing 9 has been removed, i.e. when the electric motor 3 is currentless.

If the user lies prone on the hull 10 of the craft, he can hold onto the grip elements 7 or gripping depressions. Operating elements of a manual control device have been integrated into one or both grip elements 7. A wireless remote control device is provided for the case where the motorized water craft is not operated in a prone position, but in such a way that the user stands on the hull 10 of the craft. It is connected with the motor control device 4 via a radio connection. The manual control device 14, which preferably communicates in a wireless fashion with the motor control device 4, is maintained in the field of view of the user on the hull 10 of the craft. If the user stands on the hull 10 of the craft, the manual control device 14 can be released from the hull 10 of the craft and used. On it, various operational states, for example the actual speed, the diving depth or the charge state of the batteries 5, 6 can be displayed.

1. A motorized watercraft with a hull of the craft, on which the user lies prone or stands, with a flow channel extending in the hull of the craft with a motor-driven water screw, wherein the electric motor and the batteries, as well as the control device for the electric motor are housed in the hull of the craft,
characterized in that
the water screw (2), the electric motor (1, 3) and the control device (4) are designed as an underwater drive unit and are placed in the flow channel (8), and
the batteries (5, 6) for the electric motor (3, 4) are placed into a separate housing (9), which is installed in the hull (10) of the craft so that it can be exchanged.

2. The motorized watercraft in accordance with claim 1,
characterized in that
the hull (10) of the craft has a surface for prone use or a platform for the user above the flow channel (8).

3. The motorized watercraft in accordance with claim 1 or 2,
characterized in that
the flow channel (8) is formed in one piece with the hull (10) of the craft.

4. The motorized watercraft in accordance with one of claims 1 to 3,
characterized in that
the flow channel (8) starts with an inflow opening (11) in the area of the bow of the hull (10) of the craft and terminates in an outflow opening (12) in the area of the stem of the hull (10) of the craft, and
the underwater drive unit is installed in the flow channel (8) as a suction device.

5. The motorized watercraft in accordance with one of claims 1 to 4,
characterized in that
the housing (9) with the batteries (5, 6) is inserted into a recess (13) formed in the underside of the hull (10) of the craft, which is arranged outside of the flow channel (10) and the inflow opening (11) in the area of the bow of the hull (10) of the craft.

6. The motorized watercraft in accordance with one of claims 1 to 5,
characterized in that
a remote control device is assigned to the underwater drive unit, which is releasably attached to the hull (10) of the craft and can be brought into operative contact with the control device (4) of the underwater unit over a wireless transmission path.

7. The motorized watercraft in accordance with one of claims 1 to 6,
characterized in that
the hull (10) of the craft has a plate, flap or the like, which can be opened, in the flow channel below the underwater drive unit, through which access to the underwater unit is provided.
